(19) United States
(12) Patent Application Publication
(10) Pub. No.: US 2007/0062734 A1
(43) Pub. Date: Mar. 22, 2007

(54) Plug connections for connecting modules of a motor vehicle cockpit to a main cable harness

(75) Inventors: Peter Appel, Hamburg (DE); Jurgen Dreyer, Schaafnem-Mosbach (DE); Heiko Schnieders, Schaafheim (DE); Levente Szoke, Dieburg (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/515,924

(22) Filed: Sep. 5, 2006

(30) Foreign Application Priority Data
Sep. 8, 2005 (DE) 10 2005 042 862.2

(51) Int. Cl. H01R 13/46

(52) U.S. Cl. 174/520

(57) ABSTRACT

Plug connections used to connect at least two modules of a motor vehicle cockpit to a main cable harness each comprise a first plug element and a second plug element which is designed as a suitable mating piece for the first plug element. Each of the first plug elements is electrically connected to the main cable harness and each of the second plug elements is electrically connected to a module cable harness which is part of one of the at least two modules. In order to simplify mounting of the modules, the plug connections are of identical design and are formed in a self-finding manner. The first plug element is in each case mechanically connected to the body of the motor vehicle and is arranged in an end region of the body, and the second plug element is mechanically fixed to an outer face, which is directed toward the end region of the body, of the respective module.

### BACKGROUND OF THE INVENTION

The present invention relates to plug connections for connecting at least two modules of a motor vehicle cockpit to a main cable harness, wherein each of the plug connections comprise a first plug element electrically connected to a main cable harness and a second plug element designed as a suitable mating piece for the first plug element and electrically connected to a module cable harness that is part of one of the at least two modules.

A trend toward modularization can be observed in modern motor vehicle cockpit designs. Therefore, an increasing number of cockpit arrangements are being proposed in which an instrument panel support is in the form of a supporting structural element and a plurality of modules can be pushed into the instrument panel support and fixed to the support. One such arrangement is described, for example, in DE 103 17 900 A1, where a driver module, a passenger module and a center console module are provided.

To date, it has been known to use a multipartite cable harness, the cockpit cable harness or main cable harness in order to supply electrical power and electrical signals to the modules. After the cockpit has been assembled, that is to say after the modules have been fixed to the instrument panel support, each of the modules is individually and manually connected to the cockpit cable harness by means of plugs. In this case, each of the plugs is located at the end of a plurality of cables which are combined to form a flexible section and branch off from the cockpit cable harness. The individual cable sections hang loosely in the cockpit region after the cockpit is assembled, and are fixed in position only by means of the plug connection. In order to connect the modules to the cockpit cable harness and therefore make electrical contact, it must be ensured that the associated plugs and sockets are accessible after the cockpit is assembled. Installation of the modules into the cockpit is accordingly relatively complicated. In addition, it is necessary to leave corresponding excess lengths at the ends of the cables, so that the plugs and sockets can actually be joined.

### SUMMARY OF THE INVENTION

An object of the present invention is to provide plug connections for at least two modules of a vehicle cockpit.

The object of the present invention is achieved by a plug connection assembly comprising at least two plug connections for respectively connecting at least two modules of a motor vehicle cockpit to a main cable harness, the plug connections being of identical design and formed in a self-finding manner. The first plug element of each plug connection is mechanically connected to the body of the motor vehicle and is arranged in an end region of the body. In this case, the end region is a region which, as seen from the interior of the vehicle outward, is located behind the cockpit in the direction of the front of the vehicle. The second plug element of each plug connection is mechanically fixed to an outer face, which is directed toward the end region of the body, of the respectively associated module.

Accordingly, the plug connections are not located at flexible cable ends but are mounted on the body and respectively on the outer face of the modules in a fixed manner, to be precise already in the position in which they are directly opposite one another in the installed state. In this way, it is possible to insert the modules into the instrument panel individually and at the same time make contact with the main cable harness as early as at the end of the insertion process. The self-finding refinement of the plug connections, which is known from DE 103 38 279 A1 for example, prevents the plug connections from being damaged as a result of fitting inaccuracies and allows automated mounting of the modules. The fault sources which result from twisting and jamming of the plugs and cannot be entirely precluded when contact is made manually are therefore reduced and the quality of the contact connection is improved. It is no longer necessary for the main cable harness to be excessively long, as a result of which installation space is saved. As a result of the plug connections on the at least two modules being of identical design, materials costs are reduced and the fault source represented by the use of incorrect plug elements during installation and when carrying out repair and maintenance work is eliminated. In addition, combination of the modules with one another is simplified, for example when interchanging a driver module and a passenger module in order to produce a right-hand-drive or left-hand-drive vehicle.

According to one embodiment of the invention, at least one of the first plug elements is mounted directly on an instrument panel support. Additional components for holding the first plug elements can therefore be dispensed with.

In a further embodiment, the at least one of the first plug elements is mounted on or in a device support which is fixed to the body. Therefore, device supports which contain a controller or a so-called body control module (BCM) are nowadays fixed, for example, to the side wall facing the motor space on that side which is directed toward the cockpit. The first plug element can then be mounted on the outside of said device support or else inside the device support by means of a corresponding opening. If arranged in the interior, the first plug element and the ends of the cables of the main cable harness which lead to said first plug element are protected by the housing of the device support.

As a further option for fixing at least one first or second plug element, the first or second plug element may be arranged on a printed circuit board. In the case of the first plug elements, the printed circuit board is then mechanically connected to the body, for example by the side wall or the instrument panel support. A second plug element is then seated on a printed circuit board which is located in the associated module. This embodiment reduces the outlay on cabling since the electronic components which are located on the printed circuit board can be supplied with the power or the signals which are supplied by the plug elements directly via conductor tracks of the printed circuit board.

Both electrical power and also signals are preferably transmitted by the plug connections, that is to say both power-carrying and signal-carrying plug pins are provided.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic diagram showing three cockpit modules with which contact is to be made; and

FIG. 2 schematically shows a longitudinal section through the passenger module along line II-II in FIG. 1.

### DETAILED DESCRIPTION OF THE PRESENTLY PREFERRED EMBODIMENTS

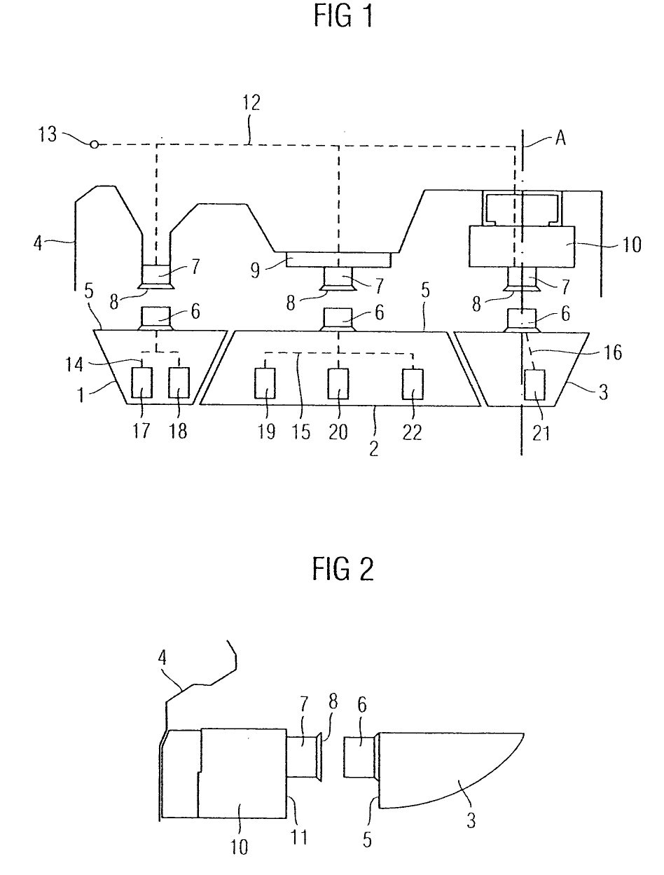

FIG. 1 shows three schematically illustrated modules of a motor vehicle cockpit: a driver module 1, a center console module 2 and a passenger module 3. These three modules each have a second plug element 6, which is of male design, on their respective outer face 5 which is directed toward an end wall 4. The second plug elements 6 are mounted on the outer faces 5 in a fixed manner and are electrically connected to module cable harnesses 14, 15 and 16 which supply power and electrical signals to electronic components 17 to 22. These electronic components may, for example, comprise an on-board computer, parts of a combination instrument, the control means of an air-conditioning system or of an air bag, or components of a multimedia or navigation device.

During installation, the three modules 1 to 3 are pushed into an instrument panel support (not illustrated) and in the process inserted into first plug elements 7 without mounting steps additionally being required. The first plug elements 7 are of a female design which is compatible with the male design of the second plug elements 6, that is to say they constitute the mating pieces for the second plug elements 6, and they are each electrically connected to the main cable harness 12. The main cable harness 12 is connected to the on-board electrical system and to the bus and signal lines of the motor vehicle at the interface 13. The edge 8 of the opening in the first plug parts 7 being conical toward the outside means that the second plug elements 6 can find their way into the first plug elements 7 even if there are small fitting inaccuracies. The first plug elements 7 are additionally mounted in a floating fashion to allow for easy position compensation and to avoid mechanical deformation.

The first plug element 7 which is part of the driver module 1 is fixed directly to the end wall 4. The first plug element 7 which is part of the center console module 2 is fixed on a printed circuit board 9 which, in turn, is mounted on the end wall 4. Depending on the circumstances, the printed circuit board 9 can further be surrounded by a shield and a mechanical protection means. The first plug element 7 of the passenger module 3 is located on a device support 10 which, in turn, is fixed to the end wall 4. A Body Control Module (BCM) is arranged in the device support 10.

FIG. 2 shows a longitudinal section along a line II-II in FIG. 1, with the cable harnesses 12 and 16 and the electronic component 21 not being illustrated. The passenger module 3 with the second plug element 6 which is fixed to the outer wall 5, and the end wall 4 with the device support 10 which is mounted on said wall and supports the first plug element 7 on its outer wall 11 which is directed toward the cockpit region. As can be seen, the edge 8 of the opening in the first plug element 7 runs conically not only in its transverse extent (as shown in FIG. 1, but also in its longitudinal extent.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A plug connection for connecting at least two modules of a motor vehicle cockpit to a main cable harness, each of the at least two modules having a module cable harness, said plug connection comprising:
at least two plug connections, each comprising a first plug element and a second plug element designed as a suitable mating piece for said first plug element, each of said first plug elements being electrically connected to the main cable harness and each of the second plug elements being electrically connected to a respective one of the module cable harnesses, said at least two plug connections being of identical design and formed in a self-finding configuration which facilitates relative alignment of the first and second plug elements during insertion, each of said first plug elements being arranged and dimensioned to be mechanically connectable to the body of the motor vehicle in an end region of the body, and each of said second plug elements being arranged and dimensioned to be mechanically fixable to an outer face of a respective one of the at least two modules which is directed toward the end region of the body such that the first and second plug elements of each of the at least two plug connections automatically form an electrical connection when the respective one of the at least two modules associated with the each of the at least two plug connections is mounted in the motor vehicle cockpit.

2. The plug connection assembly of claim 1, wherein at least one of said first plug elements is arranged and dimensioned to be mounted directly on an instrument panel support.

3. The plug connection assembly of claim 1, further comprising a device support arranged and dimensioned to be fixed to the body, wherein at least one of said first plug elements is mounted on or in the device support.

4. The plug connection assembly of claim 1, further comprising a printed circuit board, wherein at least one of said first or second plug elements is arranged on said printed circuit board.

5. The plug connection assembly of claim 1, wherein each of said at least two plug connections contain both power-carrying and signal-carrying plug pins.
